(19) United States
(12) Patent Application Publication
(10) Pub. No.: US 2025/0392470 A1
(43) Pub. Date: Dec. 25, 2025

(54) Influence Forecasting Engine for Predictive Influence Trajectory Modeling

(71) Applicant: George William Bickerstaff, Greenwich, CT (US)

(72) Inventor: George William Bickerstaff, Greenwich, CT (US)

(21) Appl. No.: 19/305,912

(22) Filed: Aug. 21, 2025

(51) Int. Cl. H04L 9/32; G06F 21/62

(52) U.S. Cl. CPC H04L 9/3239; G06F 21/6254

(57) ABSTRACT

The Global Influence Ledger (GIL) is a distributed ledger system and method for securely recording and verifying influence, trust, reputation, and governance events in a decentralized network. It includes a smart schema layer for data structuring with time-based decay rules, an event logging module for timestamping and hashing, a distributed node framework for consensus verification, an identity anchoring layer with privacy-preserving proofs and biometric hashing to prevent Sybil attacks, and a permissioned access interface for querying and auditing with Merkle proofs. The system ensures immutability, transparency, and interoperability, preventing fraud and enabling portable reputation across ecosystems.

### CROSS-REFERENCE TO RELATED APPLICATIONS

This application claims the benefit of U.S. Provisional Patent Application No. 63/847,248, filed on Jul. 20, 2025, the entire contents of which are incorporated herein by reference.

### DEFINITIONS

The following terms, when used in this specification and the appended claims, have the meanings set forth below (alphabetically sorted):

| Term | Definition |
|---|---|
| Alignment Declaration | A recorded event indicating an entity's membership in or exit from a |
| | governance-aligned group, timestamped for immutability. |
| Biometric Hashing | A cryptographic transformation of biometric identifiers used for |
| | anchoring identity without disclosing raw data. |
| Consensus Mechanism | A protocol (e.g., Raft, Proof-of-Stake) ensuring agreement among |
| | distributed nodes on ledger entries. |
| Decay Function | A rule applied within schema to reduce the weight of influence over |
| | time for relevance. |
| Distributed Ledger | A decentralized database replicated across nodes, ensuring |
| Technology (DLT) | immutability via cryptographic hashing and consensus. |
| Event Detection | Identification of a new influence-related event for ledger inclusion. |
| Event Hashing | Generating a fixed-length cryptographic digest (e.g., SHA-256) for an |
| | event to ensure data integrity. |
| Influence Score | A numerical or categorical value representing an entity's reputation or |
| | impact, derived from peer validations, algorithmic calculations, or |
| | external inputs. |
| Merkle Proof | A cryptographic proof using a Merkle tree to verify a transaction's |
| | inclusion in a ledger block without revealing the entire block. |
| Privacy-Preserving | Cryptographic methods (e.g., zk-SNARKs) that verify data attributes |
| Proofs | while maintaining user privacy. |
| Smart Schema | An extensible data format (e.g., JSON-LD) defining rules for |
| | recording influence-related events, including validation thresholds and |
| | decay rules. |
| Time-Based Rules | Rules within the identity layer applying temporal constraints, such as |
| Section | expiration or renewal of certifications. |
| Trust Certification | A digital endorsement or signature from a verified entity, attesting to |
| | an identity's authenticity or event validity. |
| Zero-Knowledge Proof | A cryptographic method (e.g., zk-SNARKs) allowing verification of |
| (ZKP) | an attribute (e.g., score above a threshold) without revealing |
| | underlying data. |

### FIELD OF THE INVENTION

The present invention relates to distributed ledger technology, blockchain systems, and data management. More specifically, it pertains to systems and methods for securely recording, verifying, and managing influence, trust, reputation, and governance-related transactions in a decentralized manner, thereby improving data integrity and privacy in digital ecosystems.

### BACKGROUND OF THE INVENTION

In digital ecosystems, influence, trust, and reputation are essential for governance, funding allocation, access control, and decision-making. Centralized systems, such as social media platforms and credit bureaus, manage reputational data but are vulnerable to single points of failure, manipulation, data fragmentation, and lack of transparency, resulting in biases, security breaches, or unauthorized alterations.

Existing distributed ledger technology (DLT) systems address reputation in limited contexts. For example, U.S. Pat. No. 9,635,000 describes blockchain-based identity management using peer-to-peer protocols but lacks extensible schemas for influence events or governance-specific features like alignment declarations. U.S. Pat. No. 11,386,050 discloses activity verification in distributed databases for purchases but omits biometric hashing or governance auditing. U.S. Patent Application Publication No. 2022/0092587 outlines self-validating blockchain networks focused on transaction integrity but not reputation portability.

Academic models, such as the Blockchain-based Trust and Reputation Model (BTRM), evaluate multi-aspect reputations but lack decay rules or governance alignments. A 2022 survey on blockchain trust systems highlights privacy-preserving techniques (e.g., zero-knowledge proofs) but identifies gaps in governance-specific applications. Research on decentralized governance (e.g., white papers on DAO frameworks) discusses decision-making but omits biometric privacy or cross-platform portability.

There remains a need for a decentralized, cryptographically secure ledger tailored to influence and trust events, ensuring immutability, transparency, and interoperability with systems for influence scoring, group alignment, trust certification, and adaptive governance. The present invention addresses these deficiencies by providing a specialized ledger with governance-specific features, privacy-preserving biometric anchoring, and cross-platform compatibility, thereby enhancing security and efficiency beyond the prior art.

### SUMMARY OF THE INVENTION

The Global Influence Ledger (GIL) is a distributed ledger system and method for recording, verifying, and managing influence-related events, including reputation scores, trust certifications, governance actions, and alignment declarations. It utilizes DLT to create an immutable, timestamped record of transactions, facilitating secure and transparent tracking across individuals, institutions, and platforms. The system enhances data integrity through cryptographic hashing, consensus mechanisms, and privacy-preserving identity anchoring, while supporting scalable interoperability with external governance platforms.

The system includes: a smart schema layer for structuring data with decay rules; an event logging module for capturing and hashing events; a distributed node framework for consensus-based verification; an identity anchoring layer for linking records to verified identities using cryptographic methods; and a permissioned access interface for querying and auditing. It enables integration with platforms for influence scoring, group alignment, trust certification, and governance, mitigating tampering and promoting reputation portability.

The method involves capturing events, validating and timestamping them, anchoring to identities, appending to the ledger via distributed nodes, and providing secure access. This framework establishes a robust integrity layer for digital influence ecosystems, differentiating from prior systems through its focus on governance-specific events, privacy enhancements, and cross-platform compatibility.

### BRIEF DESCRIPTION OF THE DRAWINGS

The accompanying drawings, which are incorporated in and constitute a part of this specification, illustrate embodiments of the invention and, together with the description, serve to explain the principles of the invention. The drawings are submitted as separate PDF files in accordance with 37 CFR § 1.84:

FIG. 1 is a block diagram of the GIL system architecture, illustrating interconnections between the smart schema layer (100), event logging module (110), distributed node framework (120), identity anchoring layer (130), permissioned access interface (140), and data flows (150).

FIG. 2 is a flowchart of the event capture and timestamping process, detailing event detection (200), validation (210), hashing (220), timestamping (230), and ledger submission (240).

FIG. 3 is a schematic of the identity anchoring and verification layer, illustrating zero-knowledge proofs (300), time-based rules section (310), biometric hashing (320), and privacy-preserving proofs (330).

FIG. 4 is a process diagram of distributed node synchronization, depicting consensus mechanism (400), node replication (410), data propagation (420), and network configurations (430).

FIG. 5 is a mockup of the audit and access permission panel, showing role-based controls (500), query interfaces (510), transaction history (520), and export options with Merkle proofs (530).

### DETAILED DESCRIPTION OF THE INVENTION

The following detailed description is provided to enable any person skilled in the art to make and use the invention. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

### System Overview

The Global Influence Ledger (GIL) is a decentralized DLT system optimized for recording and verifying influence, trust, reputation, and governance events. Unlike general-purpose blockchains (e.g., Ethereum), the GIL employs custom schemas and protocols to enhance data integrity, privacy, and scalability for reputational transactions.

### Core Components

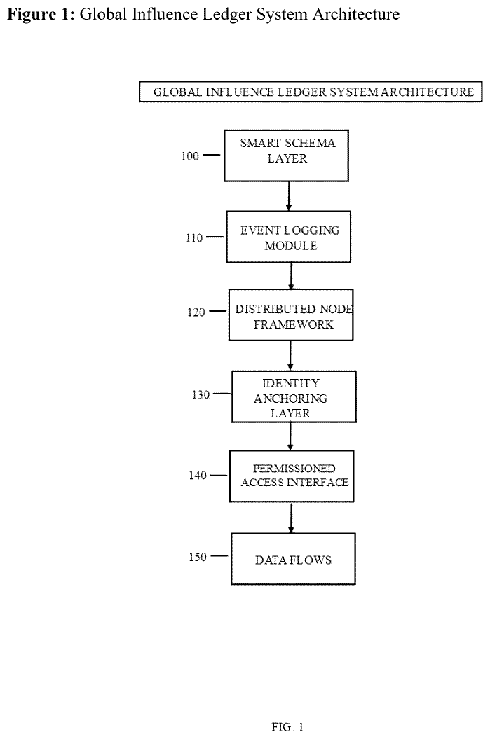

The smart schema layer (100) defines extensible data structures (e.g., JSON-LD) for reputational transactions. An example schema includes fields for event type (e.g., score update), influence score, source (e.g., peer validation), and timestamp. It enforces rules such as time-based decay to reduce influence weight over time and minimum thresholds for peer endorsements (e.g., at least three). The layer is compatible with external systems via formats like JSON-LD or Protocol Buffers. See FIG. 1 (100).

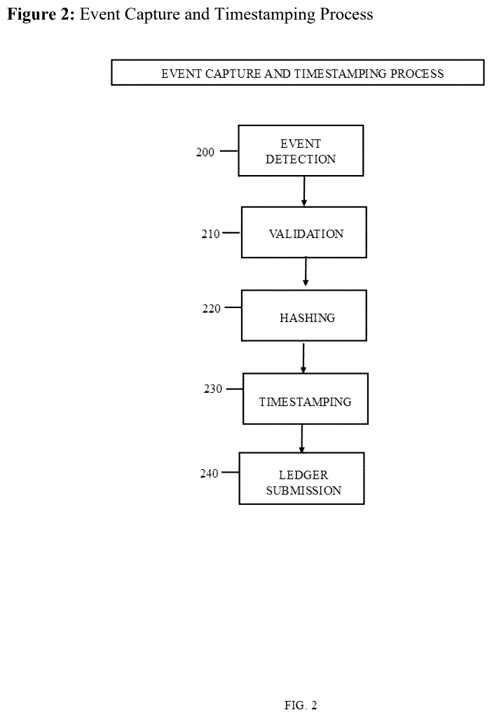

The event logging module (110) captures events (e.g., score updates, trust certifications) through real-time APIs or batch processing. The process includes detection (200), schema validation (210), hashing with SHA-256 (220), timestamping using UTC via NTP (230), and submission to the ledger (240). See FIG. 2 (110 in FIG. 1).

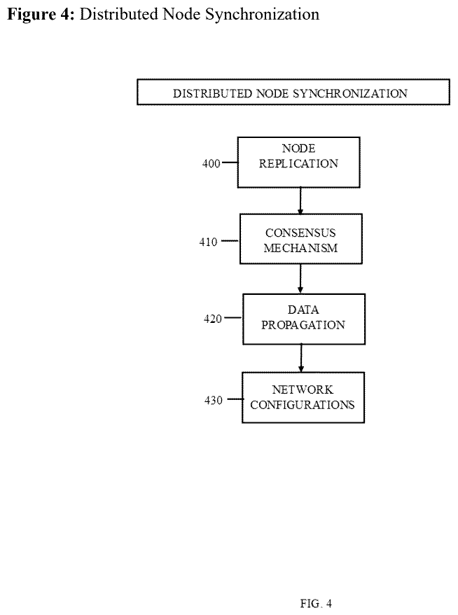

The distributed node framework (120) replicates the ledger across permissioned (e.g., Raft) or public (e.g., Proof-of-Stake) nodes. It incorporates node replication (410), consensus mechanism (400), data propagation (420), and network configurations (430). Scalability is achieved through sharding or sidechains, with verified transactions appended as immutable blocks. See FIG. 4 (120 in FIG. 1).

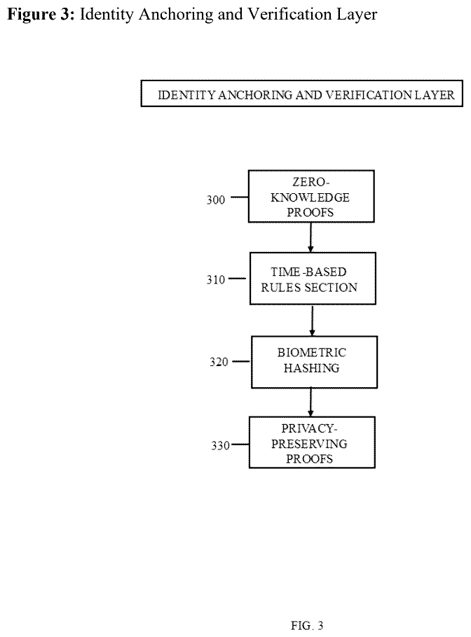

The identity anchoring layer (130) links records to verified identities using pseudonymous hashes (e.g., Keccak-256), Decentralized Identifiers (DIDs), zero-knowledge proofs (300), time-based rules (310), biometric hashing (320), and privacy-preserving proofs (330). This layer complies with privacy regulations such as GDPR by minimizing data disclosure. See FIG. 3 (130 in FIG. 1).

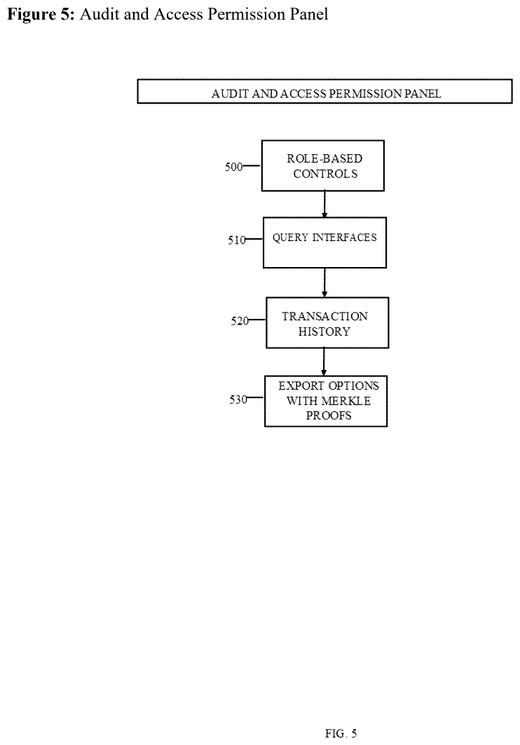

The permissioned access interface (140) provides OAuth-secured RESTful APIs and a graphical user interface for queries (e.g., by identity or event type). It includes role-based controls (500), query interfaces (510), transaction history views (520), and exports with Merkle proofs (530). See FIG. 5 (140 in FIG. 1).

Data flows (150) interconnect the components as illustrated in FIG. 1.

### Operational Method

The method, executed by one or more processors, comprises: capturing events (e.g., API-driven score updates) via event detection (200, FIG. 2); validating against schemas (210), hashing with SHA-256 (220), and timestamping with UTC (230); anchoring to identities using signatures or proofs (300-330, FIG. 3); broadcasting to nodes for consensus and block appending (400-430, FIG. 4); and providing AES-256-encrypted access and audit logs (500-530, FIG. 5).

### Interoperability

The GIL integrates with external platforms (e.g., DAO voting tools, HR systems) via APIs, facilitating event flows for influence scoring, group alignment, and trust certifications. Cross-chain bridges enable compatibility with networks like Ethereum.

### Advantages

The GIL advances the prior art by: logging governance-specific events (e.g., alignment declarations) not addressed in financial or IP-focused blockchains; enabling cross-platform reputation portability, unlike siloed systems; enhancing privacy through zero-knowledge proofs and biometric hashing; supporting regulatory compliance with Merkle proof exports; reducing computational overhead via schema validation; and scaling with sharding, sidechains, and hybrid consensus.

### EMBODIMENTS

In one embodiment, an enterprise governance network integrates with HR platforms for employee reputation tracking, utilizing biometric hashing for identity verification.

In another embodiment, public nodes incorporate machine learning for anomaly detection in scores, improving fraud prevention.

In a further embodiment, interoperability with Ethereum DAOs is achieved via bridges, applying time-based decay for portable scores. Additional variations include mobile applications for event submission and GDPR-compliant notifications.

What is claimed is:

1. A distributed ledger system for tracking influence-related events, comprising: a processor; and a memory storing instructions that, when executed by the processor, cause the system to implement: a smart schema layer (100) configured to record influence scores and trust actions in an extensible format, incorporating time-based decay rules to enhance data relevance; an event logging module (110) configured to capture (200), validate (210), and hash (220) discrete events using a cryptographic algorithm, with timestamping (230) and ledger submission (240) to ensure data integrity; a distributed node framework (120) configured to verify and replicate ledger data across a network of nodes via node replication (410), a consensus mechanism (400), data propagation (420), and network configurations (430) to improve scalability; an identity anchoring layer (130) configured to link records to verified identities using zero-knowledge proofs (300), a time-based rules section (310), biometric hashing (320), and privacy-preserving proofs (330) to prevent Sybil attacks while ensuring privacy; and a permissioned access interface (140) configured to enable querying (510) and auditing (520) of ledger contents with role-based controls (500) and export options with Merkle proofs (530) to enhance regulatory compliance.

2. A method for managing influence-related events in a distributed ledger system, the method executed by a processor and comprising: capturing reputational and governance events from integrated sources via event detection (200); validating (210) the events against a predefined schema in a smart schema layer (100) with time-based decay rules, and timestamping (230) with a universal time reference; anchoring each event to a verified identity using cryptographic signatures or proofs in an identity anchoring layer (130), including zero-knowledge proofs (300), a time-based rules section (310), biometric hashing (320), and privacy-preserving proofs (330); writing the anchored events to a distributed ledger by broadcasting to nodes and achieving consensus via a distributed node framework (120), including node replication (410), a consensus mechanism (400), data propagation (420), and network configurations (430); and providing secure, queryable access to ledger contents through a permissioned access interface (140) with export capabilities (530) including verifiable proofs.

3. A non-transitory computer-readable medium storing instructions that, when executed by one or more processors, cause the one or more processors to: receive an influence-related event from an external system via event detection (200); hash (220) and timestamp (230) the event using a cryptographic hash function and universal time; link the event to a verified identity via an identity anchoring layer (130) with biometric hashing (320) and zero-knowledge proofs (300), including a time-based rules section (310) and privacy-preserving proofs (330); append the linked event to a distributed ledger through consensus among nodes in a distributed node framework (120), including node replication (410), a consensus mechanism (400), data propagation (420), and network configurations (430); and facilitate audited access to the ledger via a permissioned access interface (140), including queries (510) filtered by event type or identity and export options with Merkle proofs (530).

4. The system of claim 1, wherein the discrete events include at least one of influence score updates, credential verifications, alignment shifts, governance actions, and trust transactions, with the time-based decay rules applied to prevent perpetual influence accumulation.

5. The system of claim 1, wherein the cryptographic algorithm is SHA-256, and the ledger data is stored as immutable blocks across the distributed nodes.

6. The system of claim 1, wherein the identity anchoring layer (130) employs zero-knowledge proofs (300) or elliptic curve digital signature algorithm signatures, integrated with biometric hashing (320) for Sybil resistance.

7. The system of claim 1, further comprising interoperability modules configured to integrate with external systems for influence scoring, group alignment, trust certification, or governance decision-making, supporting cross-chain data portability.

8. The system of claim 1, wherein the consensus mechanism (400) includes Raft for permissioned networks or Proof-of-Stake for public networks, with sharding for scalability.

9. The system of claim 1, wherein the smart schema layer (100) includes time-based decay rules stored in the memory to model relevance over time.

10. The method of claim 2, wherein validating (210) includes hashing (220) with SHA-256 and checking compliance with validation thresholds, including peer endorsement minimums.

11. The method of claim 2, wherein anchoring uses zero-knowledge proofs (300) and biometric hashing (320) to verify attributes without revealing identity data.

12. The method of claim 2, further comprising replicating ledger data across nodes, handling scalability through sharding or sidechains, and applying time-based decay rules.

13. The method of claim 2, wherein providing secure access includes implementing role-based controls (500) and encrypting communications using AES-256.

14. The method of claim 2, wherein the reputational and governance events include influence score updates based on peer feedback, trust certifications from verified entities, and alignment declarations with temporal constraints (310).

15. The medium of claim 3, wherein the instructions further cause integration with external systems for automated event ingestion, supporting GDPR-compliant data flows.

16. The medium of claim 3, wherein linking uses biometric hashing (320) or decentralized identifiers compliant with privacy regulations, enhanced by zero-knowledge proofs (300).

17. The medium of claim 3, wherein consensus is achieved using a protocol supporting permissioned and public node configurations, with majority voting to prevent single-node dominance.

18. The medium of claim 3, wherein audited access includes generating Merkle proofs (530) for off-chain verification of ledger integrity, enabling portable reputation exports.
